(19) United States
(12) Patent Application Publication
(10) Pub. No.: US 2007/0299996 A1
(43) Pub. Date: Dec. 27, 2007

(54) Data Transfer Device

(76) Inventors: Gideon Guy, Chatsworth, CA (US); Eugenio Allevato, Northridge, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/426,868

(22) Filed: Jun. 27, 2006

(51) Int. Cl. G06F 13/38

(52) U.S. Cl. 710/63

(57) ABSTRACT

There is disclosed a data transfer device to allow a host to access a universal serial bus (USB) storage device as if it were a hard disk drive. The data transfer device may include a first interface unit to allow for communication with a host and a second interface unit to allow for communication with the USB storage device. The data transfer device may include a transfer logic unit to allow the host to access the USB storage device as if the USB storage device were a hard disk drive. The transfer logic unit may prevent harmful commands from reaching the USB storage device.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

The disclosure relates to accessing data from a source medium as if the source medium were a hard disk drive.

2. Description of the Related Art

Computers, portable digital assistants (PDAs), cellular telephones, portable music players (e.g., MP3 players), and other computing devices have become ubiquitous in modern society. Students use computing devices for communicating with friends, professors and teachers; for writing computer software; for drafting papers; for taking notes; and for other purposes. Business people use computing devices for communicating with colleagues and clients; for writing documents; for preparing presentations; and for other purposes. The vast majority of people use computing devices for beneficial purposes. However, computing devices may also be put to malicious use. Criminals of all kinds use computing devices to further their goals. White collar criminals may use computing devices to steal private banking or financial information from companies and individuals. Sex offenders may use computing devices to view illegal pornography and entrap children and adults in illegal schemes. Terrorists may use computing devices to plan evil acts. Just as the list of beneficial uses of computing devices is endless, so is the list of malicious and criminal uses.

These computing devices often have a universal serial bus (USB) interface that allows for the transfer of data stored on removable or permanent media included in or coupled to an external storage device. When a computing device is used for criminal purposes, evidence of the offender's criminal acts may be stored on a storage device that was externally coupled to the computing device. Investigative agencies such as police, secret service, district attorney, Federal Bureau of Investigation and other organisations may obtain an offender's storage device as evidence of criminal activity. In such circumstances, the integrity of the evidence on the external storage device must be maintained while the data on the storage device is examined for evidence of malicious acts. That is, investigators must preserve the content of the storage device as of the time the storage device was taken into evidence while the investigators evaluate its contents. Example storage devices include USB flash memory drives which are commonly referred to as thumb drives, pen drives, pocket drives and jump drives.

### DESCRIPTION OF THE DRAWINGS

FIG. 1 is a block diagram of a personal computer having installed therein a data transfer device as described herein.

FIG. 2 is a block diagram of a data transfer device as described herein coupled between a USB storage device and a forensic device.

FIG. 3 is a block diagram of a data transfer device described herein.

FIG. 4 is a flow chart of the actions taken by a data transfer device described herein.

FIG. 5 is a flow chart of the actions taken by a data transfer device having write blocking features as described herein.

### DETAILED DESCRIPTION

Throughout this description, the embodiments and examples shown should be considered as exemplars, rather than limitations on the apparatus and methods disclosed or claimed.

The systems and methods described herein allow for the accessing of a storage medium as if the storage medium were a hard disk drive. More specifically, the systems and methods described herein allow for access to a universal serial bus (USB) attached flash memory storage medium as if the storage medium were a hard disk drive. This may be achieved by coupling the USB storage medium with a hard disk drive controller via a data transfer device, as explained in more detail herein. In another embodiment, the systems and methods described herein also allow for access to data on a USB attached flash memory storage medium while preserving the contents of the storage medium. In another embodiment, the systems and methods described herein also allow a USB attached writeable flash memory storage medium to be accessed in a read-only manner.

As used herein, the term “storage medium” refers to a medium for storing data including magnetic disks such as hard disks and floppy disks, optical disks such as readable and writeable compact disks (CD-RW) and digital versatile disks (DVD-RW), magnetic tape, and solid state flash memory cards such as, for example, CompactFlash brand memory cards, Multi-Media Card (MMC) cards, SmartMedia brand memory cards, Secure Digital (SD) brand memory cards, Memory Stick brand memory sticks, flash memory drive media (also known as thumb drives, pen drives and jump drives), and other readable and writeable storage media. As used herein, a storage device is a device that allows for reading and writing to a storage medium. As used herein, the terms storage device may include a storage medium. This is particularly so in the case of transportable flash memory devices which may be referred to as thumb drives, pen drives, pocket drives and jump drives. The storage device may be included with or otherwise coupled or attached to a computing device.

A computing device as used herein refers to any device with a processor, memory and a storage device that may execute instructions including, but not limited to, personal computers, server computers, computing tablets, set top boxes, video game systems, personal video recorders, telephones, cellular telephones, personal digital assistants (PDAs), portable computers, laptop computers, digital media players, digital music players such as MP3 players, and others. These computing devices may run operating systems, including, for example, variations of the Linux, Unix, MS-DOS, Microsoft Windows, Palm OS, and Apple Mac OS X operating systems and may provide support for Java or other languages in the form of Java interpreters and runtime environments, known as, for example, Java Virtual Machines.

Devices

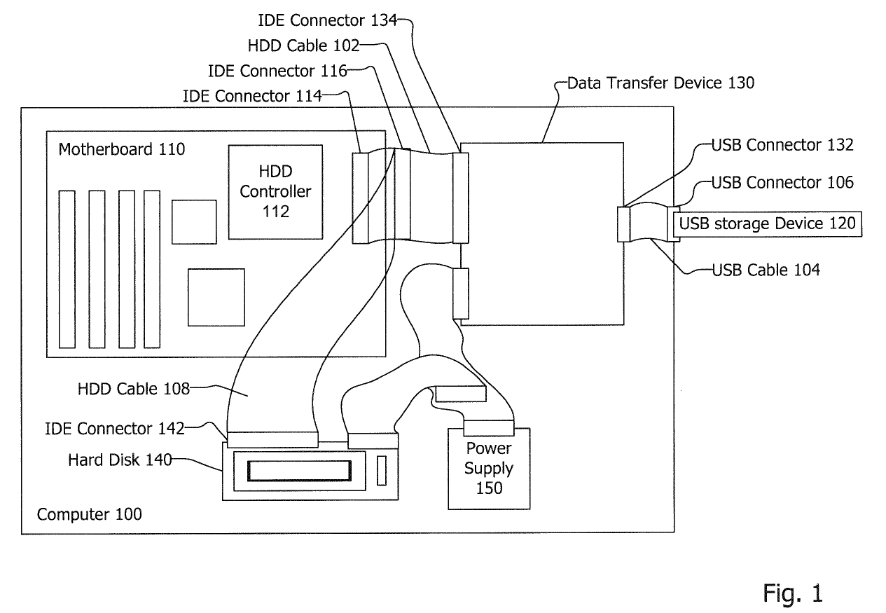

FIG. 1 is a block diagram of a personal computer 100 having installed therein a data transfer device 130 as described herein. In this embodiment, the data transfer device 130 is coupled between the hard disk drive controller 112 on motherboard 110 and an external USB storage device 120. The external USB storage device 120 may be a flash memory drive that includes a permanently installed storage medium commonly referred to as thumb drives, pen drives, pocket drives and jump drives; a microdrive hard disk; an external hard disk; or may be a computing device capable of communicating using the USB protocol and including a permanent storage medium such as incorporated flash memory or a removable storage medium such as, for example, a flash memory card. These devices are known as USB mass storage devices. The external USB storage device 120 may be a device capable of data storage and communicating via the USB protocol, namely a USB mass storage device.

Data transfer device 130 allows a user of personal computer 110 to read data from USB storage device 120 as if the USB storage device 120 were a hard disk drive. The data transfer device 130 emulates a hard disk drive so that the computer 110 will recognize USB storage device 120 as if it were a hard disk drive, regardless of the type of storage medium included in or otherwise coupled with the USB storage device 120. The data transfer device 130 may also provide non-destructive access to external USB storage device 120. Further, data transfer device 130 may replace any attempts to write or erase data on the USB device 120 with a harmless replacement command, and may emulate any expected responses to the personal computer 110. A harmless replacement command is a command that does not write data to, erase data from or otherwise alter the contents of external USB storage device 120.

The external USB storage device 120 may be coupled with computer 100 via a USB connector 106 included in the personal computer 100. In other embodiments, the external USB storage device 120 may be coupled to the USB connector 106 of personal computer 100 via a USB cable.

As mentioned above, the data transfer device 130 may be coupled between the hard disk drive controller 112 on motherboard 110 and the external USB device 120. To achieve this coupling, in place of the typical connection internal to personal computer 100 between USB device connector 106 and a USB host controller on the motherboard 110 via an internal USB cable, a USB connector 132 on the data transfer device 130 is used to couple the data transfer device 130 with USB connector 106 using a USB cable 104. Similarly, via an Integrated Drive Electronics (IDE) connector 134 on data transfer device 130, the data transfer device may be coupled with a hard disk drive (HDD) cable 102 to IDE connector 114 on the motherboard 110. The data transfer device 130 may be coupled directly to the motherboard 110 or may be coupled to an existing hard disk drive cable included in personal computer 100. The existing hard disk drive 140 may be coupled to the motherboard 110 using hard disk drive cable 108 via an IDE connector 142 on the hard disk drive 140 and an IDE connector 116 on the hard disk drive cable 102. Hard disk drive cables 102 and 108 may be portions of the same hard disk drive cable, or may be separate cables.

In one embodiment, the hard disk drive 140 conforms to a version of the Advanced Technology Attachment (ATA) standards or other hard disk drive standard, and the hard disk drive cables 102 and 106 are one or more ribbon cables that conform to the ATA standards or other hard disk drive standard. As used herein, the term hard disk drive standard includes ATA, the ATA Packet Interface (ATAPI), IDE, Enhanced IDE (EIDE), ATA-2, Fast ATA, Ultra-DMA, ATA-33, DMA-33, ATA/66 Ultra ATA and ATA/100, serial ATA (SATA and S-ATA), small computer system interface (SCSI), for example, and other hard disk standards. The hard disk 140 may be an ATA/IDE compatible hard disk and/or may be compatible with other hard disk standards. The format of the hard disk may be any format, such as, for example, File Allocation Table 16 bit (FAT-16), FAT-32, new technology file system (NTFS), and Hierarchical File System (HFS).

In other embodiments, the hard disk drive cables 102 and 106 having IDE connectors may have other connectors and be in another format that conforms to one or more other hard disk drive standards. Similarly, the data transfer device 130 may have one or more connectors one of which may conform to the IDE standard, and one or more of which may conform to other standards, for example, USB, IEEE 1394, HDD (as defined above), and Fibre Channel standards. These standards are referred to herein as data transfer standards.

Although the data transfer device 130 is shown as coupled to the USB storage device 120 via USB connectors 132 and 108 and USB cable 104, in another embodiments, the USB storage device 120 may conform to another standard such as the IEEE 1394 (more commonly known as firewire) standard. In other embodiments, the USB storage device may conform to any of a variety of other data transfer standards. As such, the USB connectors 106 and 132 and the USB cable 104 may be replaced with any corresponding connectors and cable conforming to one or more other data transfer standards.

The data transfer device 130 may include software, firmware, hardware and/or a combination of these for providing the functionality and features described herein. A data transfer device may include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the data transfer device 130 may include various specialized units, circuits, software and interfaces for providing the functionality and features described herein. Additional and fewer units, modules or other arrangement of software, hardware and data structures may be used to achieve the processes and apparatuses described herein.

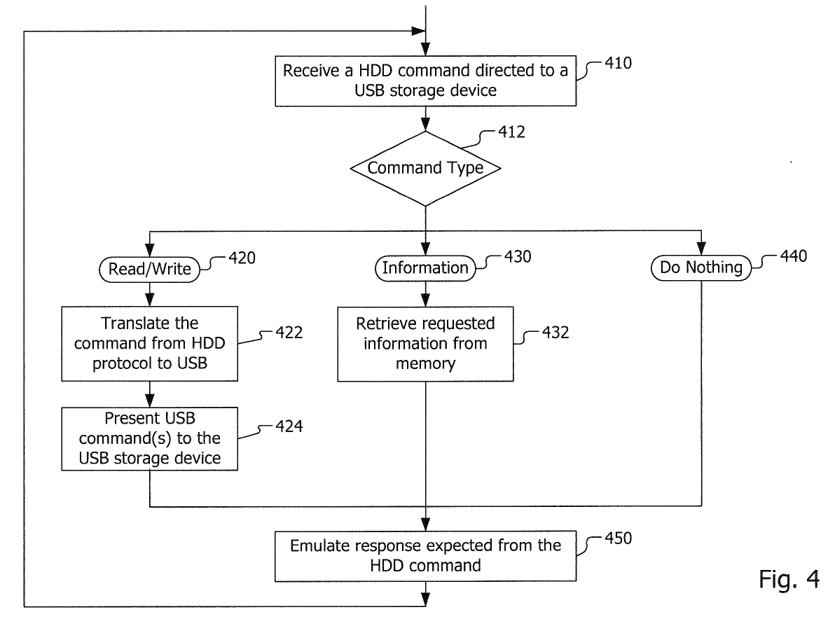

The data transfer device 130 emulates a hard disk drive such that the computer treats the USB device 120 as if it were a hard disk drive. The data transfer device 130 may monitor all commands that are directed to the USB storage device 120 from the personal computer 110. Generally, the data transfer device 130 intercepts all hard disk drive commands directed to the USB device 120, determines the type of HDD command or instruction, and, based on the determination: (1) translates the command from a HDD command to a USB command or commands, and presents the command or commands to the USB storage device 120; (2) retrieves requested information from the USB storage device 120; or (3) does nothing. In addition, a response expected from the HDD command may be emulated. This is discussed in more detail below regarding FIG. 4.

In addition, in one embodiment, the data transfer device 130 intercepts all hard disk drive commands directed to the USB device 120 the determines whether they are harmful or benign. As used herein, a benign command is a command that accesses the storage device without erasing any data from or writing any data to the storage medium. Benign commands include read, seek, and the like. Harmful commands are those commands which would cause alteration of the content of the USB device 120, such as writing data or erasing data. Harmful commands that cause alteration of the storage medium would cause the evidentiary value of the storage medium to be compromised.

If the data transfer device 130 determines that the command is benign, data transfer device 130 may translate or transcode the hard disk drive command into a USB command and pass the translated command to the USB storage device 120. If the data transfer device 130 determines that the command is harmful, data transfer device 130 may replace the harmful command with a benign replacement USB command and pass the benign replacement USB command to the USB storage device 120. The data transfer device 130 may emulate responses expected to result from the harmful hard disk drive command and may pass the emulated hard disk drive response to the personal computer 110.

Power for the hard disk 140 and the data transfer device 130 may come from a power supply 150 included in the personal computer 150.

Although shown implemented in conjunction with a personal computer 100, the data transfer device 130, in the embodiment shown or in other embodiments, may be coupled in or with other computing devices.

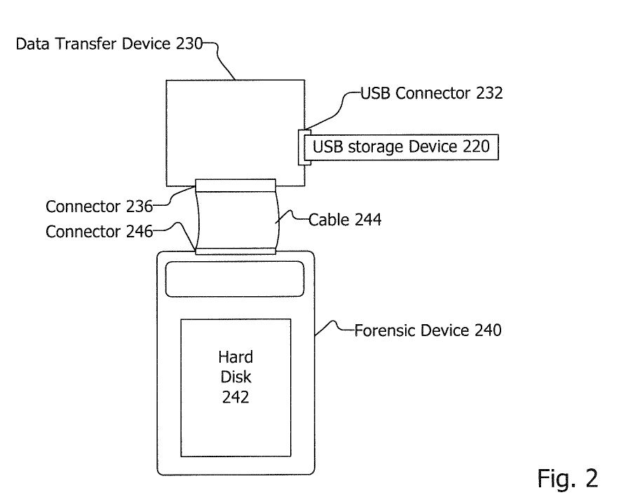

FIG. 2 is a block diagram of a data transfer device as described herein coupled between a USB storage device 220 and a forensic device 240. In this configuration, the forensic device 240 may be used to make a copy of the data from the USB storage device 220 on a hard disk drive 242 or other storage media or storage device included in or coupled with the forensic device 240. Depending on the certifications and properties of the forensic device 240, an authenticated certified copy of the information on USB storage device 220 may be obtained and stored for use as evidence in a court of law. In one embodiment, the information from the USB storage device 220 may also be analyzed using the forensic device 240 without any risk of altering the data on the USB storage device 220.

As shown in FIG. 2, data transfer device 230 may be coupled between a USB storage device 220 and a forensic device 240. The forensic device 240 may include a hard disk drive 242. Example forensic devices include the SF-5000 and the MD5 available from Logicube, Inc. of Chatsworth, Calif. Data transfer device 230 is used to emulate a hard disk drive. The USB storage device 220 may be coupled directly to the data transfer device 230 via a USB connector included in, attached to, or integrated with the data transfer device 230. In other embodiments, the USB device may be coupled with the USB connector 232 of data transfer device 230 using a USB cable.

The forensic device 240 may be coupled with the data transfer device 230 via connector 244 on the forensic device 240 and cable 244 and connector 236 on the data transfer device 230. In one embodiment, the connectors 236 and 246 and cable 244 conform to the IDE standard. In other embodiments, the connectors 236 and 246 and cable 244 may conform to other hard disk drive and data transfer standards.

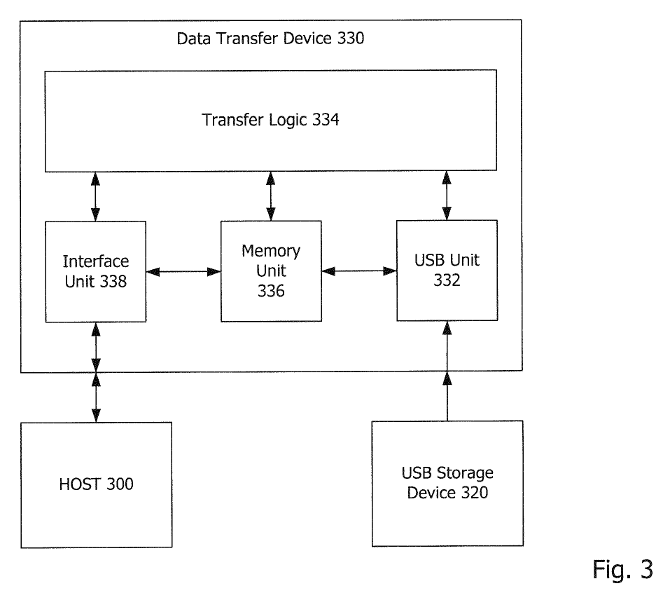

FIG. 3 is a block diagram of a data transfer device 330. The data transfer device 330 may be the data transfer devices 130 and 230 described above regarding FIGS. 1 and 2. The data transfer device 330 may be used to copy or otherwise transfer data from a USB storage device 320 to a host 300. In one embodiment, the data transfer device 330 allows the USB storage device 320 to appear to the host as if the USB storage device 320 were a hard disk drive that conforms to the IDE, ATA, S-ATA, or other hard disk drive standard. The host 300 is typically a device used by a member of law enforcement, an analyst associated with law enforcement or investigation, or other person wishing to obtain a copy of the information included on the USB storage device 320. The information to be retrieved may be used to obtain evidence of a crime or other malfeasance and/or for investigation thereof.

As described above, in one embodiment, the USB storage device 320 is a USB flash memory drive, commonly referred to as thumb drives, pen drives, pocket drives and jump drives. In other embodiments, the USB device may be any computing device capable of communicating using the USB protocol, including for example, cellular telephones, MP3 players, external hard disk drives, external tape drives, and others. In one embodiment, the host 300 is a computing device or the motherboard of a computing device, such as, for example, computer 100 and motherboard 110 shown in FIG. 1. In another embodiment, the host 300 is a forensic device like forensic device 240 shown in FIG. 2. The host device 300 has a hardware connector that allows the host 300 to be coupled with the data transfer device 330. In various embodiments, the host 300 may be coupled with the data transfer device according to one or more HDD and data transfer standards and the corresponding physical connectors, such as, for example, IDE, ATA, S-ATA, SCSI, USB, and others.

The data transfer device 330 may include a combination of hardware, software, and/or firmware to achieve is functionality. The data transfer device 330 may include one or more functional units or modules. Each of the functional units or modules or the entirety of the functional units or modules may be incorporated on one or more PLDs, FPGAs, ASICs, etc. The data transfer device 330 may include a USB unit 332 to allow for communication with the USB storage device 320 according to the USB protocol. The data transfer device 330 may include an interface unit 338 to allow for communication with the host 300. One or more interface units 338 may be included in the data transfer device. The interface unit 338 may be a HDD interface unit that conforms to one or more HDD standards. Each of the interface units, when there is more than one interface unit, may provide support for one or more different data transfer standards. The one or more interface units 338 may each provide support for one or more data transfer standards, including, for example, but not limited to, IDE, ATA, S-ATA, SCSI, USB, and others.

In one embodiment, some of the functionality of the data transfer device 330 is implemented using the CY4640 chip and portions of the CY4640 Mass Storage Reference Design Kit available from Cypress Semiconductor Corporation of San Jose Calif.

To facilitate efficient transfer of data from the USB storage device 320 via USB unit 332, the data transfer device 330 may include a memory unit 336 coupled between the USB unit 332 and the interface unit 338. The memory unit 336 may be a direct memory access (DMA) unit or other memory device that allows for fast transfer of data such as by block transfers. The memory unit 336 is optional. In other embodiments, the USB unit 332 and interface unit 338 may communicate with one another directly and/or through the transfer logic 334.

The data transfer device 330 may include transfer logic 334. The transfer logic 334 provides the interface between USB unit 332 and interface unit 338. The transfer logic 334 may translate, transcode or otherwise map commands in the data transfer command set associated with interface unit 338 to the appropriate USB commands used by the USB unit 332. In one embodiment, the transfer logic 334 translates, transcodes or otherwise maps commands in a HDD command set associated with the interface unit 338 to the appropriate USB commands of the USB unit 332. The transfer logic 334 may receive via interface unit 338 HDD commands from host 300, may translate or transcode the HDD commands into one or more a USB commands, and may pass the translated command to the USB storage device 320 via USB unit 332. The transfer logic 334 may also emulate responses expected from the HDD commands which are not included in the USB specification or are different in the USB specification.

In one embodiment, the transfer logic 334 may convert all HDD commands received from interface unit 338 and all USB commands, responses and data received from USB unit 332 into SCSI commands, responses and data. In this way, all of the processing performed internally to the transfer logic 334 may be between two SCSI devices.

In one embodiment, the transfer logic 334 may be augmented to further include data transfer limitations and/or write blocking features. To achieve this additional functionality, the transfer logic 334 may also evaluate whether a command issued by the host 300 is benign. If so, the transfer logic 334 may translate or transcode the hard disk drive command received via interface unit 338 into a USB command and pass the translated command to the USB storage device 320. If the transfer logic 334 determines that the command is harmful, the transfer logic 334 may replace the harmful command with a benign replacement USB command and pass the benign replacement USB command to the USB storage device 320. In addition or in the alternative, the transfer logic 334 may pass no command to the USB storage device 320 if the command received from the host 300 is harmful. The transfer logic 334 may also emulate any required response expected to result from a harmful hard disk drive command and pass the emulated hard disk drive response to the host 300 via interface unit 338.

Methods

Referring now to FIG. 4, there is shown a flow chart of the actions taken by the data transfer device described herein. The blocks shown in this drawing may be performed by data transfer devices 130, 230 and 330 described above regarding FIGS. 1, 2 and 3. The data transfer device may receive a HDD command directed to a USB storage device, as shown in block 410. The HDD command may be evaluated to determine the type of HDD command received, as shown in block 412. The HDD command may be a read/write command—that is, a command that writes data to or reads data from a hard disk. When the HDD command is a read/write command, as shown in block 420, the command may be translated from the HDD protocol to one or more commands of the USB protocol to achieve the function associated with the HDD command, as shown in block 422. The one or more USB commands are presented to the USB storage device, as shown in block 424. In certain circumstances, a response expected from the HDD command may be emulated, as shown in block 450. When the HDD command is a read command, the response may include data read from the USB storage device. When the hard disk drive command is a write command, the response may include an acknowledgement that data was written to the USB storage device. The flow of actions then returns to block 410.

The HDD command may be an information command—that is, a command that seeks information about a storage device, such as, for example, total size of the storage device, sector size, drive speed, seek speed, read speed, write speed, and other features of and functionality of the hard disk drive. When the HDD command is an information command, as shown in block 430, the requested information may be retrieved from memory in the data transfer device, as shown in block 432. In this embodiment, the data transfer device obtains storage device information from a USB storage device and stores the USB storage device information upon start up, boot up, or power on in memory. Some of the storage device information may be emulated or stated based on typical or expected values, such as, for example, seek time for which there is no corresponding parameter on a USB storage device. In another embodiment, information about the USB storage device may be retrieved and/or emulated in response to an information command. A response expected from the HDD command may be emulated, as shown in block 450. The response may include information requested in the HDD information command. The flow of actions then returns to block 410.

In some situations, there is no USB command and no sequence of USB commands that can be used to achieve the function of the received HDD command. In these situations, the HDD command may be considered a “do nothing” command such that no actions are taken in response to receiving the HDD command, as shown in block 440. Even in the case of “do nothing” commands, in certain circumstances, a response expected from the HDD command may be emulated, as shown in block 450. The flow of actions then returns to block 410.

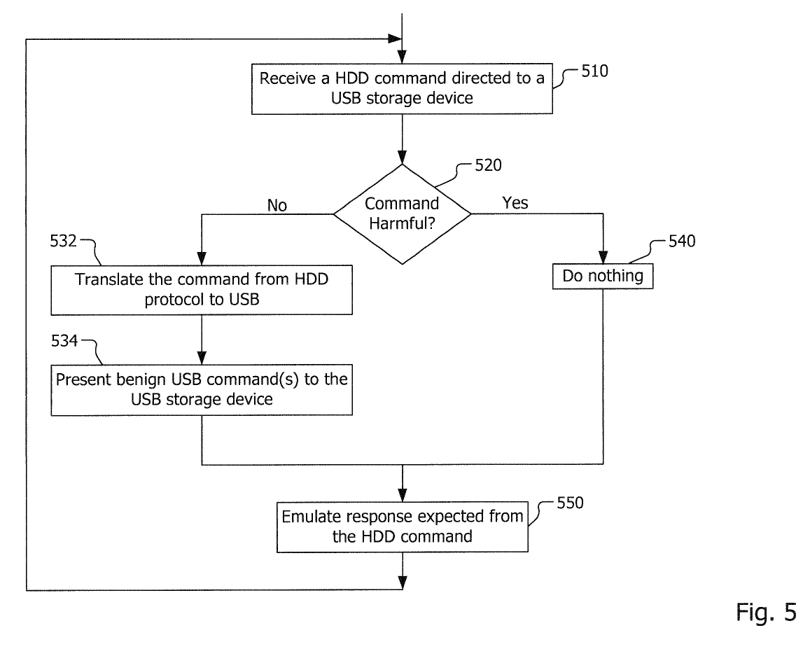

FIG. 5 is a flow chart of the actions taken by a data transfer device augmented with write blocking features. The actions shown in FIG. 5 may be performed in conjunction with and/or in addition to the actions described regarding and shown in FIG. 4. The actions shown in FIG. 5 may be performed by data transfer devices 130, 230 and 330 described above regarding FIGS. 1, 2 and 3. The data transfer device may receive a HDD command directed to a USB storage device, as shown in block 510. The HDD command may be evaluated to determine whether it is harmful, as shown in block 520. If the command is not harmful, that is, if the command is benign, the command may be translated from the HDD protocol to one or more commands of the USB protocol to achieve the function associated with the HDD command, as shown in block 532. The one or more benign USB commands are presented to the USB storage device, as shown in block 534. In certain circumstances, a response expected from the HDD command may be emulated, as shown in block 550. The flow of actions then returns to block 510.

If the command is harmful, as shown in block 520, the harmful command may be ignored such that nothing is done, as shown in block 540. In another embodiment, the harmful command may be evaluated to determine whether the harmful command should be translated into one or more a benign USB replacement commands and presented to the storage device. A response expected from the HDD command may be emulated, as shown in block 550. The flow of actions then returns to block 510.

Closing Comments

The foregoing disclosure is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein “and/or” means that the listed items are alternatives, but the alternatives also include any combinations of the listed items.

It is claimed:

1. A data transfer device comprising:
a first interface unit to allow the data transfer device to communicate with a host;
a second interface unit to allow the data transfer device to communicate with a universal serial bus (USB) storage device;
a transfer logic unit to allow the host to access the USB storage device as if the USB storage device were a hard disk drive.

2. The data transfer device of claim 1 wherein the host is a computing device.

3. The data transfer device of claim 1 wherein the host is a forensic device.

4. The data transfer device of claim 1 wherein the host is a computer.

5. The data transfer device of claim 1 wherein the first interface conforms to one or more of a plurality of hard disk drive (HDD) standards.

6. The data transfer device of claim 1 wherein the first interface conforms to one or more of the Integrated Drive Electronics (IDE), Advanced Technology Attachment (ATA), small computer system interface (SCSI), and Fibre Channel standards.

7. The data transfer device of claim 1 wherein the host is a motherboard of a computer.

8. The data transfer device of claim 1 wherein the USB storage device is a flash memory drive.

9. The data transfer device of claim 1 wherein the USB storage device is one of a flash memory thumb drive, a flash memory jump drive, and a flash memory pen drive.

10. The data transfer device of claim 1 wherein the USB storage device a flash memory device having a flash memory storage medium include therein.

11. The data transfer device of claim 1 wherein the transfer logic is configured to:
evaluate a type of hard disk drive command received;
if the hard disk drive command is a read/write command,
translate the hard disk drive command into a universal serial bus command or commands, and
present the universal serial bus command or commands to the USB storage device;
if the hard disk drive command is an information command, retrieve requested information
if the hard disk drive command is a do nothing command, do nothing.

12. The data transfer device of claim 11 wherein the transfer logic is further configured to:
emulate a response expected from the hard disk drive command.

13. The data transfer device of claim 1 wherein the transfer logic is configured to:
evaluate a type of hard disk drive command received;
if the type of the hard disk drive command is a read/write command,
translate the hard disk drive command into one or more universal serial bus commands,
present the one ore more universal serial bus commands to the USB storage device, and
emulate a response expected from the hard disk drive command, the response including read data when the hard disk drive command is a read command.

14. The data transfer device of claim 1 wherein the transfer logic is configured to:
evaluate a type of hard disk drive command received;
if the type of the hard disk drive command is an information command,
retrieve requested information, and
emulate a response expected from the hard disk drive command, the response including the requested information.

15. The data transfer device of claim 1 wherein the transfer logic is configured to:
evaluate commands received from the host, and
emulate an expected response when a current command is harmful to the USB storage device.

16. The data transfer device of claim 1 wherein the transfer logic is further configured to:
emulate an expected response to the host when a current command is harmful to the storage device.

17. The data transfer device of claim 1 wherein the transfer logic is configured to:
evaluate commands received from the host, and
ignore a current command when the current command is harmful to the USB storage device.

18. A data transfer device comprising:
a first interface unit to allow the data transfer device to communicate with a host according to a hard disk drive standard;
a second interface unit to allow the data transfer device to communicate with a universal serial bus (USB) storage device;
a transfer logic unit to allow the host to access the USB storage device as if the USB storage device were a hard disk drive, the transfer logic configured to
evaluate a type of hard disk drive command received from the host;
if the type of the hard disk drive command is a read/write command,
translate the hard disk drive command into a universal serial bus command or commands,
present the universal serial bus command or commands to the USB storage device via the second interface;
if the type of the hard disk drive command is an information command,
retrieve requested information.

19. The data transfer device of claim 18 wherein the transfer logic unit is further configured to:
emulate a response expected from the hard disk drive command,
the response including the requested information when the type of the
hard disk drive command is the information command,
the response including read data when the type of the hard disk drive
command is the read command;
provide the response to the host via the first interface.

20. The data transfer device of claim 18 wherein the host is one selected from the group comprising:
a computing device, a forensic device, and a computer.

21. The data transfer device of claim 18 wherein the first interface is a hard disk drive interface that conforms to one or more of a plurality of hard disk drive standards.

22. The data transfer device of claim 21 wherein the hard disk drive interface conforms to one or more of the Integrated Drive Electronics (IDE), Advanced Technology Attachment (ATA), small computer system interface (SCSI), and Fibre Channel standards.

23. The data transfer device of claim 18 wherein the USB storage device is a flash memory drive.

24. A device to transfer data from a universal serial bus (USB) storage device which prevents modification of the USB storage device, the device comprising:
a hard disk drive interface to connect the device to a host;
a USB interface to connect to the device to the USB storage device;
a transfer logic to evaluate commands received from the host, and to emulate an expected response when the current command is harmful to the storage device.

25. The device of claim 24 wherein the host is one selected from the group comprising:
a computing device, a forensic device, and a computer.

26. The device of claim 24 wherein the hard disk drive interface conforms to one or more of a plurality of hard disk drive (HDD) standards.

27. The device of claim 24 wherein the hard disk drive interface conforms to one or more of the Integrated Drive Electronic (IDE), Advanced Technology Attachment (ATA), small computer system interface (SCSI), and Fibre Channel standards.

28. The device of claim 24 wherein the USB storage device is a flash memory drive.
